(19) United States
(12) Patent Application Publication
(10) Pub. No.: US 2024/0067046 A1
(43) Pub. Date: Feb. 29, 2024

(54) STATE OF CHARGE BALANCING IN SPLIT BATTERY SYSTEM

(71) Applicant: Atieva, Inc., Newark, CA (US)

(72) Inventors: Mingkai Mu, Fremont, CA (US); Harrison Senor, Newark, CA (US); Richard J. Biskup, Sunnyvale, CA (US); Gregory Tzermias, San Francisco, CA (US)

(21) Appl. No.: 18/344,353

(22) Filed: Jun. 29, 2023

Related U.S. Application Data
(60) Provisional application No. 63/373,934, filed on Aug. 30, 2022.

(51) Int. Cl. B60L 58/22; H02J 7/00

(52) U.S. Cl. CPC B60L 58/22; H02J 7/0014; B60L 2240/547

(57) ABSTRACT

An electric vehicle comprises: a battery system split into first and second sectors substantially equal to each other; a first bidirectional DC/DC converter, the first bidirectional DC/DC converter being galvanically isolated and coupled to the first sector; and a second bidirectional DC/DC converter, the second bidirectional DC/DC converter being galvanically isolated and coupled to the second sector; wherein the first and second bidirectional DC/DC converters balance respective states of charge of the first and second sectors before the first and second sectors are connected in parallel.

This application claims benefit, under 35 U.S.C. § 119, of U.S. Provisional Patent Application No. 63/373,934, filed on Aug. 30, 2022, entitled “STATE OF CHARGE BALANCING IN SPLIT BATTERY SYSTEM”, the disclosure of which is incorporated by reference herein in its entirety.

### TECHNICAL FIELD

This document relates to state of charge (SOC) balancing in a split battery system.

### BACKGROUND

The battery voltages of newly developed electric vehicles and plug-in hybrid electric vehicles (collectively: electric vehicles) continue to reach higher levels. For example, some electric vehicles may have battery voltages of 800V or higher. Charging stations, on the other hand, may still support only voltages lower than this level, such as below 750V or 500V.

### SUMMARY

In an aspect, an electric vehicle comprises: a battery system split into first and second sectors substantially equal to each other; a first bidirectional DC/DC converter, the first bidirectional DC/DC converter being galvanically isolated and coupled to the first sector; and a second bidirectional DC/DC converter, the second bidirectional DC/DC converter being galvanically isolated and coupled to the second sector; wherein the first and second bidirectional DC/DC converters balance respective states of charge of the first and second sectors before the first and second sectors are connected in parallel.

Implementations can include any or all of the following features. The electric vehicle further comprises an onboard charger, wherein the first and second bidirectional DC/DC converters are part of the onboard charger. The onboard charger has a multistage architecture that further includes a power factor correction stage. The power factor correction stage is common to the first and second bidirectional DC/DC converters. The electric vehicle further comprises a load for the battery system, the load comprising a first load coupled to the first bidirectional DC/DC converter, and a second load coupled to the second bidirectional DC/DC converter. The first and second sectors are connected in parallel at least for charging of the battery system. The first and second sectors are connected in series at least for driving an inverter of the electric vehicle. The electric vehicle further comprises a first busbar that connects: a positive terminal of the first bidirectional DC/DC converter, a positive terminal of the first sector, and a positive terminal of the second sector through a first contactor between the positive terminal of the first sector and the positive terminal of the second sector. The electric vehicle further comprises a second busbar that connects: a negative terminal of the second bidirectional DC/DC converter, a negative terminal of the second sector, and a negative terminal of the first sector through a second contactor between the negative terminal of the second sector and the negative terminal of the first sector. The electric vehicle further comprises a third busbar that connects the negative terminal of the first sector and the positive terminal of the second sector through a third contactor between the negative terminal of the first sector and the positive terminal of the second sector. The first and second contactors are opened, and the third contactor is closed, to connect the first and second sectors in series. The first and second contactors are closed, and the third contactor is opened, to connect the first and second sectors in parallel.

### BRIEF DESCRIPTION OF DRAWINGS

FIG. 1 shows an example of a system that can perform SOC balancing of a split battery system using a DC/DC converter.

FIG. 2 shows an example of the system of FIG. 1 being charged using a native voltage DC fast charger.

FIG. 3 shows an example of the system of FIG. 1 being charged using a legacy voltage DC fast charger.

Like reference symbols in the various drawings indicate like elements.

### DETAILED DESCRIPTION

This document describes examples of systems and techniques providing a new power architecture and control method for an electric vehicle. The electric vehicle is provided with a battery system that is split into at least two sectors. SOC balancing between the sectors of the battery system can be performed by a DC/DC converter of the electric vehicle. For example, this can be a galvanically isolated bidirectional DC/DC converter that is part of an onboard charging system of the electric vehicle.

As mentioned, battery systems of the present disclosure are split into sectors, and these sectors can be connected with each other in series or in parallel to adapt to different voltage ranges of DC charging solutions (e.g., DC fast chargers). In some implementations, a high-voltage DC fast charger can provide a voltage of about 800V to about 1000V. For example, these chargers can be referred to as native chargers with respect to an electric vehicle whose battery system has a native voltage in the range of such a high-voltage DC fast charger. In older electric vehicles, by contrast, the battery system typically had a lower voltage than those of modern high-voltage DC fast chargers and are sometimes referred to as “legacy battery systems.” The previous generation of DC fast chargers that were designed for such battery systems were then lower-voltage DC fast chargers. In some implementations, a lower-voltage DC fast charger can provide a voltage of about 400V to about 500V.

The reason to use a split battery system, and to balance the SOC or voltage between the battery sectors, can be to make the vehicle backward compatible with lower-voltage DC fast chargers, sometimes referred to as legacy voltage DC fast chargers. When a vehicle having a split battery system detects that the DC fast charger supports the native battery voltage, the vehicle can connect the battery sectors in series. On the other hand, when such a vehicle detects a legacy voltage DC fast charger, the sectors can be connected in parallel. When the sectors are switched between series and parallel connections, their respective voltage/SOC should be as close to each other as possible. For example, this can avoid inrush current, energy waste, or potential overheating of the system or any of its cells.

Examples herein refer to a vehicle. A vehicle is a machine that transports passengers or cargo, or both. A vehicle can have one or more motors using at least one type of fuel or other energy source (e.g., electricity). The term electric vehicle as used herein includes any vehicle having at least one electric traction motor, including, but not limited to battery electric vehicles and plug-in hybrid electric vehicles. Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons.

Examples herein refer to a battery system, which is an assembly of electrochemical cells. A battery system can be configured to power an electric motor for propulsion, or to provide a stationary power supply, to name just two examples. A battery system can include control circuitry for managing the charging, storage, and/or use of electrical energy in the electrochemical cells, or the battery system can be controlled by an external component. For example, a battery management system can be implemented on one or more circuit boards (e.g., a printed circuit board).

Examples herein refer to electrochemical cells. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrochemical cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples herein refer to alternating current (AC) or direct current (DC). Different voltage levels and current levels can be used for each of AC and DC. The example voltages mentioned herein are for illustrative purposes only. A DC/DC converter can be bidirectional, meaning that it can convert DC to DC in either direction between its respective terminals. A DC/DC converter can be galvanically isolated, meaning that the input side and the output side of the DC/DC converter do not share a common ground, and that the DC/DC converter has a transformer that eliminates any DC path between the input side and the output side.

Examples described herein describes certain components of an electric circuit as being coupled or connected to each other. As used herein, being coupled or connected means to be electrically coupled or connected, unless otherwise stated.

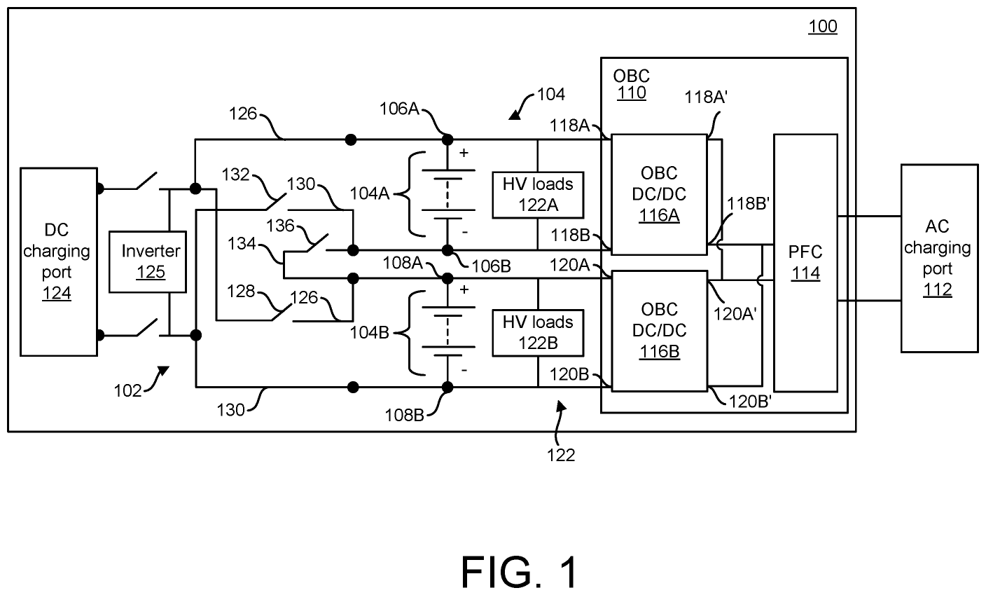

FIG. 1 shows an example of an electric vehicle 100 including a system 102 that can perform SOC balancing of a split battery system using a DC/DC converter. The electric vehicle 100 and/or the system 102 can be used with one or more other examples described elsewhere herein. The electric vehicle 100 is here shown schematically and many components thereof are omitted for simplicity (including, but not limited to, vehicle body, wheels, electric traction motor, power electronics, and a thermal system.)

The electric vehicle 100 includes a battery system 104 that can be split into multiple sectors. Here, the battery system 104 includes a sector 104A and a sector 104B. Each of the sectors 104A-104B includes multiple electrochemical cells. The respective numbers of cells in the sectors 104A-104B may not necessarily be the same. However, if the sectors 104A-104B are to be connected in parallel with each other (e.g., as exemplified below) they should have about the same voltage as each other. The sector 104A has a positive terminal 106A (i.e., a terminal having a positive potential difference compared to a reference) and a negative terminal 106B (i.e., a terminal having a negative potential difference compared to the reference). Similarly, the sector 104B has a positive terminal 108A and a negative terminal 108B.

The system 102 includes a busbar 134 that controls the whether the sectors of the split battery system are connected in series or parallel. Here, the busbar 134 connects the negative terminal 106B of the sector 104A and the positive terminal 108A of the sector 104B. The busbar 134 can include at least one contactor. For example, here a contactor 136 is located between the negative terminal 106B of the sector 104A and the positive terminal 108A of the sector 104B. When the contactor 136 is closed and contactors 128 and 132 (to be described below) are open, the sectors 104A-104B of the battery system 104 are connected in series. When the contactor 136 is open and the contactors 128 and 132 are closed, the sectors 104A-104B are connected in parallel.

The electric vehicle 100 can have an onboard charger 110 (OBC) that can be used for charging the battery system 104 with electricity from an external power source. Here, an AC charging port 112 is indicated as an example. The onboard charger 110 can have one or more power stages, for example a multistage architecture. In some implementations, the onboard charger 110 has a stage that converts AC from the AC charging port 112 to DC. This can be done using a power factor correction stage 114 (PFC). For example, the power factor correction stage 114 can include a rectifier and optionally one or more filters to convert the AC power into power for a DC intermediate bus in the electric vehicle 100.

In some implementations, the onboard charger 110 has a stage that is implemented for generating DC suitable for the battery system 104. This can be done using one or more DC/DC converters. Here, the system 102 has a DC/DC converter 116A for the sector 104A, and a DC/DC converter 116B for the sector 104B. The DC/DC converter 116A has a positive terminal 118A and a negative terminal 118B. The DC/DC converter 116A also has a positive terminal 118A′ and a negative terminal 118B′. Similarly, the DC/DC converter 116B has a positive terminal 120A and a negative terminal 120B, and a positive terminal 120A′ and a negative terminal 120B′. Here, the DC/DC converter 116A is coupled to the power factor correction stage 114 by the positive terminal 118A′ and the negative terminal 118B′, and is coupled to the sector 104A by the positive terminal 118A and the negative terminal 118B. Similarly, the DC/DC converter 116B is coupled to the power factor correction stage 114 by the positive terminal 120A′ and the negative terminal 120B′, and is coupled to the sector 104B by the positive terminal 120A and the negative terminal 120B. In some implementations, the respective right sides of the DC/DC converters 116A and 116B can be in parallel with each other. Here, the positive terminal 118A′ is connected with the positive terminal 120A′; similarly, the negative terminal 118B′ is connected with the negative terminal 120B′. The DC/DC converters 116A and 116B can share the same bus voltage and the power can flow from one of the DC/DC converters 116A-116B to the other. For example, this can allow the DC/DC converters 116A-116B to share the charging power as well as to balance the sectors 104A-104B.

Each of the DC/DC converters 116A-116B can be bidirectional so that it can perform DC/DC conversion in either direction. For example, the DC/DC converter 116A can use the positive terminal 118A′ and the negative terminal 118B′ as input terminals, and the positive terminal 118A and the negative terminal 118B as output terminals. As another example, the DC/DC converter 116A can use the positive terminal 118A and the negative terminal 118B as input terminals, and the positive terminal 118A′ and the negative terminal 118B′ as output terminals. The DC/DC converter 116B can use the positive terminal 120A′ and the negative terminal 120B′ as input terminals, and the positive terminal 120A and the negative terminal 120B as output terminals, and can use the positive terminal 120A and the negative terminal 120B as input terminals, and the positive terminal 120A′ and the negative terminal 120B′ as output terminals.

Each of the DC/DC converters 116A-116B can be galvanically isolated. In some implementations, this can protect the battery system 104 from unwanted electrical conditions that may occur at the AC charging port 112. For example, each of the DC/DC converters 116A-116B can have a transformer separating its side that is presently used as input from the side that is presently used as output.

The electric vehicle 100 can include high voltage loads 122. High voltage here signifies that the high voltage loads 122 can be powered using a voltage that is on the order of the voltage across the sector 104A or the sector 104B, respectively. For example, each of the sectors 104A and 104B can have a voltage that is approximately half of the nominal voltage of the battery system 104. Here, a high voltage load 122A is coupled to the sector 104A, and a high voltage load 122B is coupled to the sector 104B. In designing or configuring the electric vehicle 100, the high voltage loads 122 may be chosen to work with half of the total battery voltage. As a comparison, another solution is to connect the high voltage loads 122A-122B across the positive terminal 118A and the negative terminal 120B. Then the inputs of the high voltage loads 122A-122B can range from a minimum voltage in parallel mode to the maximum voltages in series mode. For example, the voltage range can be from about 200V to about 925V. Instead, the high voltage loads 122A-122B are connected to the respective sectors 104A-104B. Then, the voltage range can be between about 200V to about 463V, which is good for the design of the respective loads. Splitting the loads between the sectors makes balancing more important because the loads may not be the same. As such, the DC/DC converters 116A-116B can be used for balancing SOC and voltage. Examples of the high voltage loads 122 include, but are not limited to, a heater, air compressor, and auxiliary power converters. These components and/or other loads can be allocated to the high voltage loads 122A-122B, respectively, so as to distribute the total load evenly in the system 102.

The electric vehicle 100 includes a DC charging port 124. In some implementations, the DC charging port 124 can be used for connecting to a DC fast charger to charge the vehicle. An inverter 125 of the electric vehicle 100 can be coupled in parallel with the DC charging port 124. For example, the inverter 125 can include switches operated to generate AC for at least one traction motor of the electric vehicle 100.

The system 102 includes a busbar 130 that connects the negative terminal 120B of the DC/DC converter 116B, the negative terminal 108B of the sector 104B, and the negative terminal 106B of the sector 104A. The busbar 130 can include at least one contactor. For example, here a contactor 132 is located between the negative terminal 108B of the sector 104B and the negative terminal 106B of the sector 104A.

The DC/DC converters 116A-116B can perform SOC balancing in the electric vehicle 100. For example, if the sector 104A has a higher SOC than the sector 104B, the DC/DC converter 116A can transfer energy from the sector 104A to a common bus of the positive terminal 118A′ and the positive terminal 120A′. At the same time, the DC/DC converter 116B transfers the energy on the common bus to the sector 104B. In this way, energy can be shifted from the sector 104A to the sector 104B. Similarly, if the sector 104B has a higher SOC than the sector 104A, the DC/DC converter 116B can transfer energy from the sector 104B to a common bus of the negative terminal 118B′ and the negative terminal 120B′, and the DC/DC converter 116A then transfers the energy on the common bus to the sector 104A. For example, such SOC balancing can protect against surge current and energy loss when the sectors 104A-104B are being connected in parallel with each other.

The electric vehicle 100 can be charged using any of multiple types of charging stations or charging equipment. When charging with DC, the electric vehicle 100 can be connected to either a high-voltage DC fast charger (e.g., having a voltage that is on the order of the native voltage of the battery system 104), or a lower-voltage DC fast charger (e.g., having a voltage that is substantially lower than the native voltage of the battery system 104). Some DC charging (e.g., the ones mentioned below) can be performed using a DC fast charger. Examples of charging sessions will now be described.

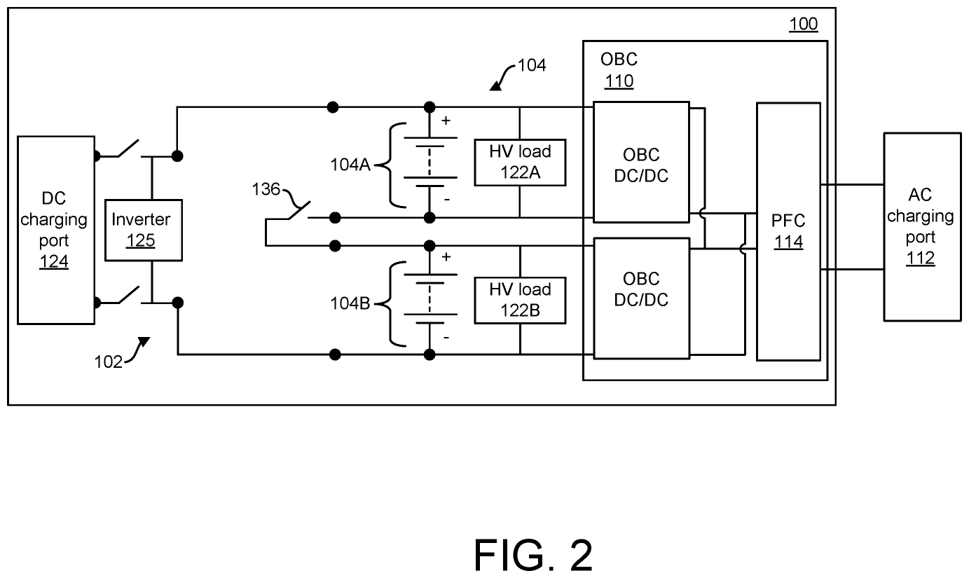

FIG. 2 shows an example of the system 102 of FIG. 1 being charged using a native voltage DC fast charger. Some aspects of the system 102 are similar or identical to the examples described with reference to FIG. 1. Only differences are described in the following. Here, the DC charging port 124 is connected to a native voltage DC fast charger that provides a relatively high voltage. Such voltage can include, but is not limited to, a potential of about 800-1000V. The voltage of the native voltage DC fast charger can be on the order of the native voltage of the battery system 104. In the handshaking procedure between the electric vehicle 100 and the charging station, the electric vehicle 100 detects the voltage of the native voltage DC fast charger and can adjust the system 102 accordingly. In some implementations, the system 102 can then connect the sectors 104A and 104B in series. For example, the contactors 128 and 132 can be opened (or kept open). The busbars 126 and 130 are not shown in this example for simplicity. The contactor 136 is closed so as to connect the sectors 104A and 104B in series. The sectors 104A and 104B can be connected in series also when driving the traction motor(s) of the electric vehicle 100.

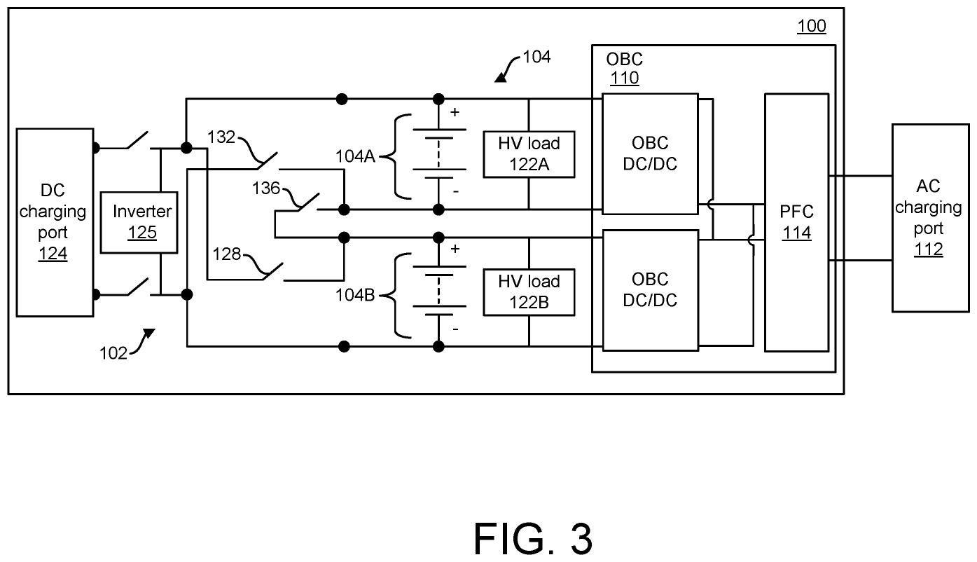

FIG. 3 shows an example of the system 102 of FIG. 1 being charged using a legacy voltage DC fast charger. Some aspects of the system 102 are similar or identical to the examples described with reference to FIG. 1. Only differences are described in the following. Here, the DC charging port 124 is connected to a legacy voltage DC fast charger that provides a relatively low voltage. Such voltage can include, but is not limited to, a potential of about 400-500V. The voltage of the legacy voltage DC fast charger can be substantially lower than the native voltage of the battery system 104. In the handshaking procedure between the electric vehicle 100 and the charging station, the electric vehicle 100 detects the voltage of the legacy voltage DC fast charger and can adjust the system 102 accordingly. In some implementations, the system 102 can then connect the sectors 104A and 104B in parallel. For example, the contactors 128 and 132 can be closed (or kept closed) and the contactor 136 can be opened (or kept open). Thus, the sectors 104A and 104B are connected in parallel.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An electric vehicle comprising:
a battery system split into first and second sectors substantially equal to each other;
a first bidirectional DC/DC converter, the first bidirectional DC/DC converter being galvanically isolated and coupled to the first sector; and
a second bidirectional DC/DC converter, the second bidirectional DC/DC converter being galvanically isolated and coupled to the second sector;
wherein the first and second bidirectional DC/DC converters balance respective states of charge of the first and second sectors before the first and second sectors are connected in parallel.

2. The electric vehicle of claim 1, further comprising an onboard charger, wherein the first and second bidirectional DC/DC converters are part of the onboard charger.

3. The electric vehicle of claim 2, wherein the onboard charger has a multistage architecture that further includes a power factor correction stage.

4. The electric vehicle of claim 3, wherein the power factor correction stage is common to the first and second bidirectional DC/DC converters.

5. The electric vehicle of claim 1, further comprising a load for the battery system, the load comprising a first load coupled to the first bidirectional DC/DC converter, and a second load coupled to the second bidirectional DC/DC converter.

6. The electric vehicle of claim 1, wherein the first and second sectors are connected in parallel at least for charging of the battery system.

7. The electric vehicle of claim 1, wherein the first and second sectors are connected in series at least for driving an inverter of the electric vehicle.

8. The electric vehicle of claim 1, further comprising a first busbar that connects: a positive terminal of the first bidirectional DC/DC converter, a positive terminal of the first sector, and a positive terminal of the second sector through a first contactor between the positive terminal of the first sector and the positive terminal of the second sector.

9. The electric vehicle of claim 8, further comprising a second busbar that connects: a negative terminal of the second bidirectional DC/DC converter, a negative terminal of the second sector, and a negative terminal of the first sector through a second contactor between the negative terminal of the second sector and the negative terminal of the first sector.

10. The electric vehicle of claim 9, further comprising a third busbar that connects the negative terminal of the first sector and the positive terminal of the second sector through a third contactor between the negative terminal of the first sector and the positive terminal of the second sector.

11. The electric vehicle of claim 10, wherein the first and second contactors are opened, and the third contactor is closed, to connect the first and second sectors in series.

12. The electric vehicle of claim 10, wherein the first and second contactors are closed, and the third contactor is opened, to connect the first and second sectors in parallel.
